(19) United States
(12) Patent Application Publication
(10) Pub. No.: US 2020/0344311 A1
(43) Pub. Date: Oct. 29, 2020

(54) METHOD FOR MANAGING A MULTI-TENANT SERVER ENCLOSURE

(71) Applicant: HEWLETT PACKARD ENTERPRISE DEVELOPMENT LP, Houston, TX (US)

(72) Inventors: Krishna Mouli Tankala, Bangalore (IN); Murali Krishna Chippagiri, Bangalore (IN); Naresh Kumar Panthangi, Bangalore (IN)

(21) Appl. No.: 16/824,580

(22) Filed: Mar. 19, 2020

(30) Foreign Application Priority Data
Apr. 24, 2019 (IN) 201941016350

(51) Int. Cl. H04L 29/08; G06F 9/50; H04L 12/24

(52) U.S. Cl. CPC H04L 67/18; H04L 67/1002; H04L 41/0893; G06F 9/5077

(57) ABSTRACT

The current invention discloses a method for managing a multi-tenant server enclosure comprising a plurality of resources including a plurality of compute servers, storage modules, and network interfaces. The method comprises defining a first virtual enclosure template for provisioning a virtual enclosure for a tenant, the virtual enclosure includes a plurality of resources comprising one or more compute servers, one or more storage modules and one or more network interfaces from the plurality of compute servers, storage modules and network interfaces; and creating a first virtual enclosure dedicated to a first tenant and a second virtual enclosure dedicated to a second tenant based on the virtual enclosure template, wherein a plurality of resources of the first virtual enclosure are physically distinct from a plurality of resources of the second virtual enclosure.

### BACKGROUND

The current invention relates to server enclosures. Server enclosures are physical devices containing a plurality of computing, storage and networking modules. Conventionally, the enclosures are deployed as single manageable entity and are managed for a single tenant.

### BRIEF DESCRIPTION OF THE DRAWINGS

The following detailed description references the drawings, wherein:

FIG. 1 is a block diagram of an example multi-tenant server enclosure;

FIG. 2 is a flowchart of an example method for managing a multi-tenant server enclosure;

FIG. 3 is an example snippet of a virtual enclosure template for managing a multi-tenant server enclosure;

FIG. 4 is a block diagram of an example controller with machine-readable medium for managing a multi-tenant server enclosure; and

FIG. 5 is a tabular representation of example QoS parameters for a network interface of a virtual enclosure.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

The current invention discloses a method for managing a multi-tenant server enclosure. Normally, enclosures comprise networking, compute, and storage capabilities; for example a fully loaded enclosure comes with a plurality of compute/storage servers, network interfaces, an enclosure manager, shared image streamer, etc. In scaled deployments, single or multi enclosures are managed as a single entity. Since there is no logical separation, often manageability of enclosures is difficult and similarly resource utilization is not optimal. Additionally, in certain cases, security challenges may present themselves. Moreover, since there is no logical separation, deployment of multiple cloud workloads belonging to various tenants in same enclosure is often challenging and requires considerable configuration. Additionally, due to the lack of logical separation, determination of resource utilization and metering for enclosures is not efficient.

Accordingly, addressing the needs mentioned above, in a first aspect, the current invention discloses a method for managing a multi-tenant server enclosure. The multi-tenant server enclosure comprises a plurality of compute servers, storage modules and network interfaces (also referred to as network interconnects). The method comprises defining a first virtual enclosure template for provisioning a virtual enclosure for a tenant, and creating a first virtual enclosure dedicated to a first tenant and a second virtual enclosure dedicated to a second tenant based on the virtual enclosure template. The virtual enclosure includes a plurality of resources comprising one or more compute servers, one or more storage modules and one or more network interfaces from the plurality of compute servers, storage modules and network interfaces. Additionally, a plurality of resources of the first virtual enclosure are physically distinct from a plurality of resources of the second virtual enclosure.

In an embodiment, defining the first virtual enclosure template includes identifying a first server image to be deployed on the first virtual enclosure and the second virtual enclosure and defining one or more policies for managing the plurality of resources of the first virtual enclosure and the plurality of resources of the second virtual enclosure. In an embodiment, the one or more polices are defined based on one or more workloads to be deployed on one of the first and second virtual enclosures.

In another embodiment, the method further comprises generating a virtual dashboard for a tenant, upon creating one of the first and second virtual enclosure, wherein the virtual dashboard displays alerts and notifications in relation to the one of the corresponding first and second virtual enclosure. In yet another embodiment, the method further comprises operating one or more resources physically distinct from the resources of the first and second virtual enclosure, in a low power mode. In yet another embodiment, the method further comprises reallocating one or more resources of the first virtual enclosure to the second virtual enclosure based on utilization of the plurality of resources of the first and second virtual enclosures.

In a second aspect, the current invention discloses a multi-tenant server enclosure. The multi-tenant server enclosure comprises a plurality of resources including a plurality of compute servers, storage modules and network interfaces; a virtual enclosure template for provisioning a virtual enclosure for a tenant; and an enclosure composer. The enclosure composer defines the virtual enclosure template, and creates a first virtual enclosure dedicated to a first tenant and a second virtual enclosure dedicated to a second tenant based on the virtual enclosure template, wherein a plurality of resources of the first virtual enclosure are physically distinct from a plurality of resources of the second virtual enclosure.

In a third aspect, the current invention discloses a non-transitory machine-readable storage medium storing instructions that, when executed by at least one processor, cause the at least one processor to define a first virtual enclosure template for provisioning a virtual enclosure for a tenant, the virtual enclosure includes a plurality of resources comprising one or more compute servers, one or more storage modules and one or more network interfaces from the plurality of compute servers, storage modules and network interfaces of a multi-tenant server enclosure; and create a first virtual enclosure dedicated to a first tenant and a second virtual enclosure dedicated to a second tenant based on the virtual enclosure template, wherein a plurality of resources of the first virtual enclosure are physically distinct from a plurality of resources of the second virtual enclosure.

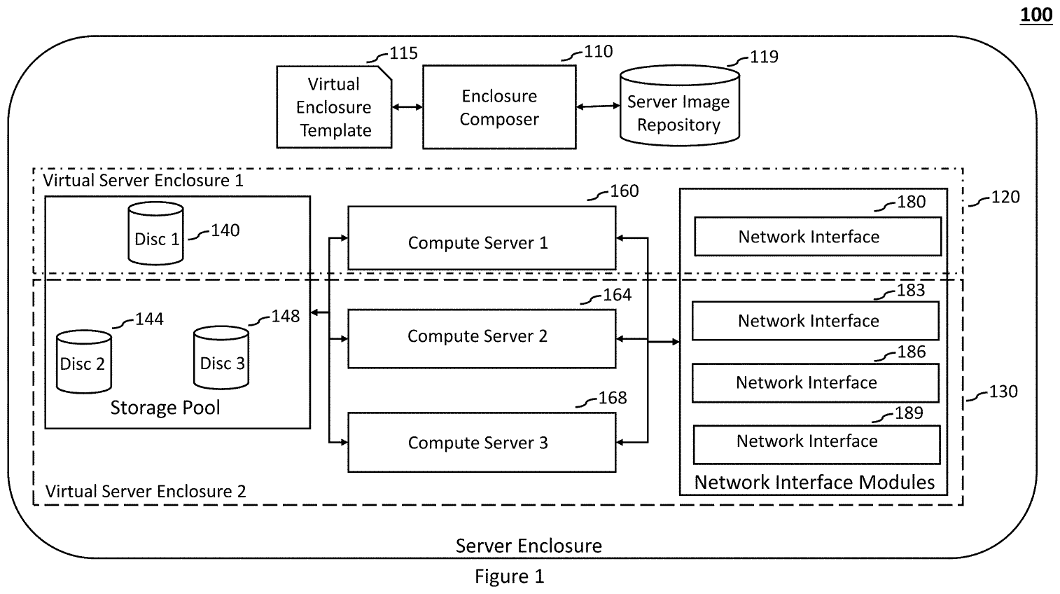

FIG. 1 is a block diagram of a multi-tenant server enclosure 100. The multi-tenant server enclosure 100 includes a plurality of resources such as a plurality of compute servers (160, 164, 168), storage modules (140, 144, 148) and network interfaces (180, 183, 186, 189). A plurality of workloads belonging to various tenants may be deployed on the resources of the multi-tenant server enclosure 100. As generally described herein, compute servers include any number of processing resources e.g., central processing units, graphics processing units, microcontrollers, application-specific integrated circuits, programmable gate arrays, and/or other processing resources. Similarly, storage modules include any storage resources e.g., random access memory, non-volatile memory, solid state drives, hard disk drives HDDs, optical storage devices, tape drives, and/or other suitable storage resources. Similarly, network interfaces include any network resources e.g., Ethernet, IEEE 802.11 Wi-Fi, and/or other suitable wired or wireless network resources, I/O resources, and/or other suitable computing hardware. Each resource may have metadata associated with it, which may be in the form of labels or annotations specifying different attributes (e.g., application configuration attributes) related to the resource. Each resource capable of being connected to every other resource in the enclosure 100 and is capable transferring data to every other resource in the enclosure 100.

The multi-tenant server enclosure 100 is segmented into one or more virtual enclosures (120, 130) on which the workloads are deployed. Each virtual enclosure is dedicated to a tenant. The multi-tenant server enclosure 100 further includes an enclosure composer 110 (also referred to as enclosure controller 110). The enclosure composer 110 is responsible for creating, configuring and managing virtual enclosures (120, 130) of the multi-tenant server enclosure 100. The enclosure composer 110 is connected to a server image repository 119. The server image repository 119 comprises a plurality of server images which may be deployed on the virtual enclosures by the enclosure composer 110. Moreover, multi-tenant server enclosure 100 includes a virtual enclosure template 115 which is used for provisioning the virtual enclosures (120, 130). The virtual enclosure template 115 contains parameters for configuration and creation of the virtual enclosure.

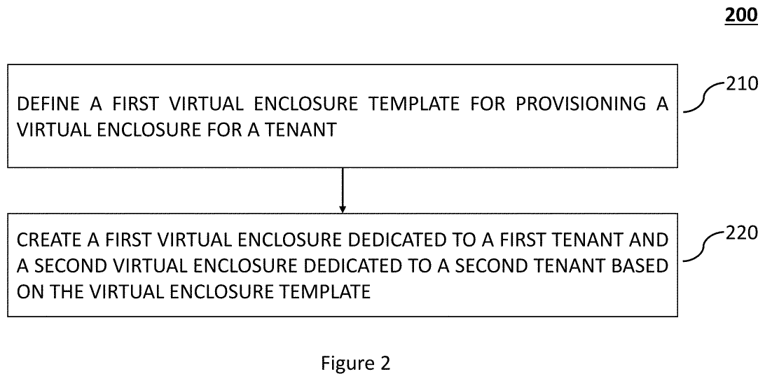

Each virtual enclosure is a logical entity comprising one or more compute servers, one or more storage modules and one or more network interfaces. The resources allocated to the virtual enclosure are dedicated to the virtual enclosure and the corresponding tenant. This allows for physical isolation amongst the tenants and therefore provides improved security and manageability. Additionally, each virtual enclosure is created automatically by the enclosure composer 110 using the virtual enclosure template 115. It is to be noted that while one virtual enclosure template 115 is shown in FIG. 1, there can be plurality virtual templates for creating virtual enclosures of varying configurations. This is further explained in the description of the FIG. 2.

FIG. 2 illustrates a method 200 for managing a multi-tenant server enclosure 100. At step 210, the enclosure composer 110 defines a first virtual enclosure template 115 for provisioning a virtual enclosure for a tenant. The first virtual enclosure template 115 contains a plurality of sections relevant to the configuration for the virtual enclosure to be provisioned using the first virtual enclosure template 115. Based on one or more tenant/workload requirements, the enclosure composer 110 defines the various aspects of the first virtual template enclosure 115. In an embodiment, the enclosure composer 110 identifies a first server image from a plurality of server images in the server image repository 119 and associates the first server image with the first virtual enclosure template 115. In an embodiment, the enclosure composer 110 populates a field in the first virtual enclosure template 115 with the details of the first server image. Accordingly, when virtual enclosures are created on the basis of the first virtual enclosure 115, the first server image is deployed on the corresponding virtual enclosures.

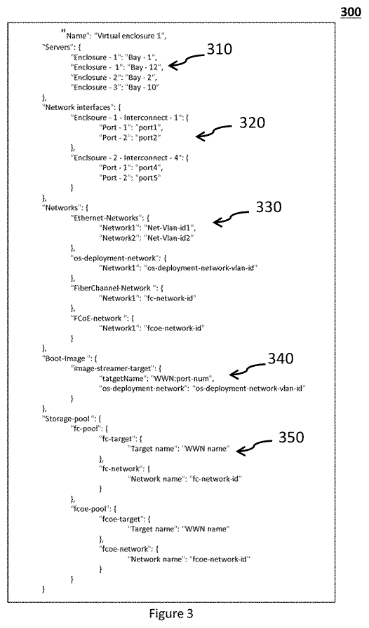

For example, FIG. 3 is an example snippet of the virtual enclosure template for managing the multi-tenant server enclosure. As shown in the FIG. 3, the section ‘boot-image’ 340 contains reference to the first server image to be deployed on the virtual enclosure upon provisioning.

In an embodiment, the enclosure composer 110 further defines one or more policies for managing the plurality of resources of the virtual enclosures in the first virtual enclosure template. For example, the enclosure composer 110 defines a network policy for the one or more network interfaces associated with a virtual enclosure. The network policy includes various Quality of Service (QoS) parameters such as application bandwidth, priority flow control, allocated bandwidth, etc. Accordingly, upon creating of the virtual enclosure using the first virtual enclosure template, the network policy is deployed in the corresponding virtual enclosure for the management of the one or more network interconnect modules of the corresponding virtual enclosure. In an embodiment, the one or more polices are defined based on one or more workloads to be deployed on one of the first and second virtual enclosures (120, 130). In an embodiment, based on the type of workload to be deployed, one or more policies may have predefined values.

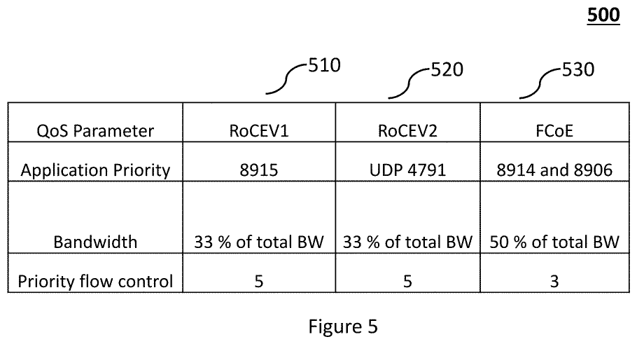

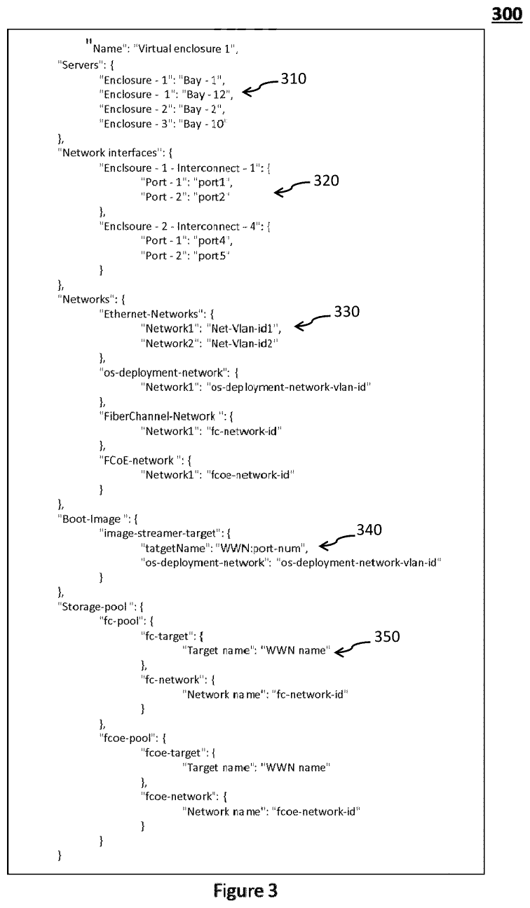

For example, FIG. 5 illustrates a tabular representation of one or more QoS parameters of a network policy associated with network interfaces of a virtual enclosure as defined in the first virtual enclosure template 115. As shown in the FIG. 5, the virtual enclosure has three network interfaces RoCEV1 510, RoCEV2 520, FCoE 530. For each of the network interface, three QoS parameters application priority, bandwidth and flow control is defined in the table 500.

Subsequent to the definition of the first virtual enclosure template 115, the enclosure composer 110 creates one or more virtual enclosures for one or more tenants at step 220. For example, as shown in FIG. 1, the enclosure composer 110 creates a first virtual enclosure 120 dedicated to a first tenant and a second virtual enclosure 130 dedicated to a second tenant, based on the first virtual enclosure template 115. The plurality of resources (140, 160, 180) of the first virtual enclosure (120) are physically distinct from a plurality of resources (144, 148, 168, 183, 186, 189) of the second virtual enclosure (130).

In an embodiment, the enclosure composer 110 generates a virtual dashboard for a tenant, upon creating a virtual enclosure based on the first virtual enclosure template. The virtual dashboard displays alerts and notifications in relation to the corresponding virtual enclosure. For example, the virtual dashboard displays performance indices, events, alerts, etc. in relation to the corresponding virtual enclosure. In an embodiment, the first virtual enclosure template includes one or more configuration parameters associated with the virtual dashboard. For example, the first virtual enclosure includes various physical parameters and operational information associated with the virtual enclosure, to be displayed in the virtual dashboard and the graphical format in which the physical parameters and operational information are to be displayed. Accordingly, based on the information displayed on the virtual dashboard, corrective/preventive actions may be taken by the tenant.

In an embodiment, the enclosure composer 110 depowers or switches the unallocated resources (e.g. one or more resources physically distinct from the resources of the first and second virtual enclosures 120, 130) of the multi-tenant server enclosure 100 to a low power mode. For example, since the compute server 164 is neither allocated to first virtual enclosure 120 or second virtual enclosure 130, the enclosure composer 110 depowers or puts the compute server 164 in a low power mode. In an embodiment, based on runtime utilization of the resources of the first and second virtual enclosures, the enclosure composer is capable of reallocating resources from one virtual enclosure to another (first to second or vice versa). For example, if the first virtual enclosure is underutilized and the workload deployed on the second virtual enclosure requires additional resources, the enclosure composer 110 based on dynamic utilization of the resources of the first and second enclosures (120 and 130), reallocates one or more resources of the first virtual enclosure 120 to the second virtual enclosure 130.

FIG. 3 illustrates an example snippet 300 of a virtual enclosure template for provisioning virtual enclosures. As illustrated in the FIG. 300, the virtual enclosure template includes plurality of sections 310, 320, 330, 340 and 350 for containing configuration information for provisioning the virtual enclosures. Section 310 is associated with range of compute servers to be assigned in the virtual enclosures. Similarly, section 320 and 330 is associated with network resources. Similarly, section 320 includes references to network interfaces which may be assigned to the virtual enclosures. Section 330 includes references to network IDs which may be utilized by the virtual enclosures for communication. Section 340 includes reference to the server image to be deployed on the virtual enclosures provisioned by the virtual enclosure template 300. Similarly, section 340 is associated with storage resources.

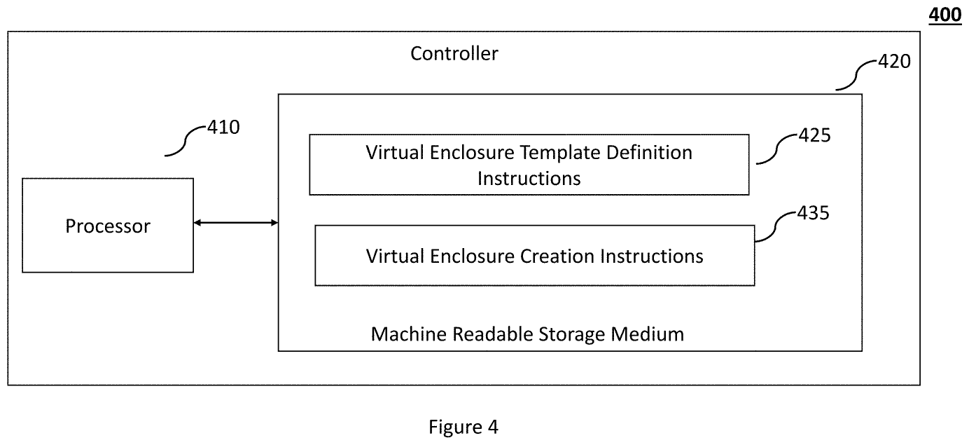

FIG. 4 is a block diagram of a controller 400 with machine-readable medium 420 for managing the multi-tenant server enclosure 100. Machine-readable medium 420 is communicatively coupled to a processor 410. In an embodiment, the controller 400 (machine-readable medium 420 and processor 410) may, for example, be included as part of multi-tenant server enclosure 100 illustrated in FIG. 1. In another embodiment, the controller 400 is composed of a thin client deployed on the multi-tenant server enclosure and a thick client deployed on a remote or cloud platform. Although the following descriptions refer to a single processor and a single machine-readable storage medium, the descriptions may also apply to a system with multiple processors and/or multiple machine-readable storage mediums. In such examples, the instructions may be distributed (e.g., stored) across multiple machine-readable storage mediums and the instructions may be distributed (e.g., executed by) across multiple processors.

Processor 410 may be central processing units (CPUs), microprocessors, and/or other hardware devices suitable for retrieval and execution of instructions stored in machine-readable storage medium 420. In the example shown in FIG. 4, processor 410 may fetch, decode, and execute machine-readable instructions 420 (including instructions 425-435) for managing the multi-tenant server enclosure 100. As an alternative or in addition to retrieving and executing instructions, processor 410 may include electronic circuits comprising a number of electronic components for performing the functionality of the instructions in machine-readable storage medium 420. With respect to the executable instruction representations (e.g., boxes) described and shown herein, it should be understood that part or all of the executable instructions and/or electronic circuits included within one box may, in some examples, be included in a different box shown in the figures or in a different box not shown.

Machine-readable storage medium 420 may be any electronic, magnetic, optical, or other physical storage device that stores executable instructions. Thus, machine-readable storage medium 420 may be, for example, Random Access Memory (RAM), a nonvolatile RAM (NVRAM) (e.g., RRAM, PCRAM, MRAM, etc.), an Electrically-Erasable Programmable Read-Only Memory (EEPROM), a flash memory, a storage drive, an optical disc, and the like. Alternatively, machine-readable storage medium 420 may be a portable, external or remote storage medium, for example, that allows a computing system to download the instructions from the portable/external/remote storage medium. In this situation, the executable instructions may be part of an “installation package”. As described herein, machine-readable storage medium 420 may be encoded with executable instructions for managing the multi-tenant server enclosure 100.

Referring to FIG. 4, virtual enclosure template definition instructions 425, when executed by processor 410, to define a first virtual enclosure template 115 for provisioning a virtual enclosure for a tenant. The first virtual enclosure template 115 contains a plurality of sections relevant to the configuration for the virtual enclosure to be provisioned using the first virtual enclosure template 115. Based on one or more tenant/workload requirements, the processor 410 defines the various aspects of the first virtual template enclosure 115. Accordingly, when virtual enclosures are created on the basis of the first virtual enclosure 115, the first server image is deployed on the corresponding virtual enclosures.

Virtual enclosure creation instructions 435, when executed by processor 410, the processor 410 creates one or more virtual enclosures for one or more tenants at step 220. For example, as shown in FIG. 1, the processor 410 creates a first virtual enclosure 120 dedicated to a first tenant and a second virtual enclosure 130 dedicated to a second tenant, based on the first virtual enclosure template 115. The plurality of resources (140, 160, 180) of the first virtual enclosure (120) are physically distinct from a plurality of resources (144, 148, 168, 183, 186, 189) of the second virtual enclosure (130).

The foregoing disclosure describes a number of example implementations for managing a multi-tenant server enclosure. The disclosed examples may include systems, devices, computer-readable storage media, and methods for managing a multi-tenant server enclosure. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Additionally, while the current invention is described in the context of enclosures, the current invention may utilized in other hardware environments.

Moreover, the disclosed examples may be implemented in various environments and are not limited to the illustrated examples. Further, the sequence of operations described in connection with FIG. 2 is an example and is not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method (200) for managing a multi-tenant server enclosure (100) comprising a plurality of resources including a plurality of compute servers (160, 164, 168), storage modules (140, 144, 148) and network interfaces (180, 183, 186, 189), the method (200) comprising:
a. defining (210) a first virtual enclosure template (115) for provisioning a virtual enclosure for a tenant, the virtual enclosure includes a plurality of resources comprising one or more compute servers, one or more storage modules and one or more network interfaces from the plurality of compute servers, storage modules and network interfaces (160, 168, 140, 144, 148, 180, 183, 186, 189);
b. creating (220) a first virtual enclosure (120) dedicated to a first tenant and a second virtual enclosure (130) dedicated to a second tenant based on the virtual enclosure template (115), wherein a plurality of resources (140, 160, 180) of the first virtual enclosure (120) are physically distinct from a plurality of resources (144, 148, 164, 168, 183, 186, 189) of the second virtual enclosure (130).

2. The method (200) as claimed in claim 1, wherein defining the first virtual enclosure template (115) includes
a. identifying a first server image to be deployed on the first virtual enclosure (120) and the second virtual enclosure (130), and
b. defining one or more policies for managing the plurality of resources (140, 160, 180) of the first virtual enclosure (120) and the plurality of resources (144, 148, 168, 183, 186, 189) of the second virtual enclosure (130).

3. The method (200) as claimed in claim 1, wherein the method (200) further comprises generating a virtual dashboard for a tenant, upon creating one of the first and second virtual enclosures (120, 130), wherein the virtual dashboard displays alerts and notifications in relation to the one of the corresponding first and second virtual enclosures (120, 130).

4. The method (200) as claimed in claim 1, wherein the method (200) further comprises operating one or more resources physically distinct from the resources of the first and second virtual enclosures (120, 130), in a low power mode.

5. The method (200) as claimed in claim 1, wherein the method (200) further comprises reallocating one or more resources of the first virtual enclosure (120) to the second virtual enclosure (130) based on utilization of the plurality of resources of the first and second virtual enclosures (120, 130).

6. The method (200) as claimed in claim 2, wherein the one or more polices are defined based on one or more workloads to be deployed on one of the first and second virtual enclosures (120, 130).

7. A multi-tenant server enclosure (100) comprising:
a. a plurality of resources including a plurality of compute servers (160, 164, 168), storage modules (140, 144, 148) and network interfaces (180, 183, 186, 189);
b. a virtual enclosure template (115) for provisioning a virtual enclosure for a tenant; and
c. an enclosure composer (110), the enclosure composer (110) for:
i. defining the virtual enclosure template (115), the virtual enclosure includes a plurality of resources comprising one or more compute servers, one or more storage modules and one or more network interfaces from the plurality of compute servers, storage modules and network interfaces (160, 164, 168, 140, 144, 148, 180, 183, 186, 189);
ii. creating (220) a first virtual enclosure (120) dedicated to a first tenant and a second virtual enclosure (130) dedicated to a second tenant based on the virtual enclosure template (115), wherein a plurality of resources (140, 160, 180) of the first virtual enclosure (120) are physically distinct from a plurality of resources (144, 148, 168, 183, 186, 189) of the second virtual enclosure (130).

8. The multi-tenant server enclosure (100) as claimed in claim 7, wherein defining the first virtual enclosure template (115) includes
a. identifying, by the enclosure composer (110), a first server image to be deployed on the first virtual enclosure (120) and the second virtual enclosure (130), the first server image stored in server image repository (119) and
b. defining, by the enclosure composer (110), one or more policies for managing the plurality of resources (140, 160, 180) of the first virtual enclosure (120) and the plurality of resources (144, 148, 164, 168, 183, 186, 189) of the second virtual enclosure (130).

9. The multi-tenant server enclosure (100) as claimed in claim 7, wherein the enclosure composer (110) further is for generating a virtual dashboard for a tenant, upon creating one of the first and second virtual enclosures (120, 130), wherein the virtual dashboard displays alerts and notifications in relation to the one of the corresponding first and second virtual enclosures (120, 130).

10. The multi-tenant server enclosure (100) as claimed in claim 7, wherein the enclosure composer (110) further is for operating one or more resources physically distinct from the resources of the first and second virtual enclosures (120, 130), in a low power mode.

11. The multi-tenant server enclosure (100) as claimed in claim 7, wherein the enclosure composer (110) further is for reallocating one or more resources of the first virtual enclosure (120) to the second virtual enclosure (130) based on utilization of the plurality of resources of the first and second virtual enclosures (120, 130).

12. The multi-tenant server enclosure (100) as claimed in claim 7, wherein the enclosure composer (110) includes a thick component deployed on a cloud platform and a thin component deployed on the multi-tenant server enclosure (100).

13. The multi-tenant server enclosure (100) as claimed in claim 8, wherein the one or more polices are defined based on one or more workloads to be deployed on one of the first and second virtual enclosures (120, 130).

14. A non-transitory machine-readable storage medium (420) storing instructions (425, 435) that, when executed by at least one processor (410), cause the at least one processor (410) to:
a. define a first virtual enclosure template (115) for provisioning a virtual enclosure for a tenant, the virtual enclosure includes a plurality of resources comprising one or more compute servers, one or more storage modules and one or more network interfaces from the plurality of compute servers, storage modules and network interfaces (160, 164, 168, 140, 144, 148, 180, 183, 186, 189) of a multi-tenant server enclosure (100);
b. create a first virtual enclosure (120) dedicated to a first tenant and a second virtual enclosure (130) dedicated to a second tenant based on the virtual enclosure template (115), wherein a plurality of resources (140, 160, 180) of the first virtual enclosure (120) are physically distinct from a plurality of resources (144, 148, 168, 183, 186, 189) of the second virtual enclosure (130).

15. The non-transitory machine-readable storage medium (420) as claimed in claim 14, wherein defining the first virtual enclosure template (115) includes
a. identifying, by the enclosure composer (110), a first server image to be deployed on the first virtual enclosure (120) and the second virtual enclosure (130), the first server image stored in server image repository (119) and
b. defining, by the enclosure composer (110), one or more policies for managing the plurality of resources (140, 160, 180) of the first virtual enclosure (120) and the plurality of resources (144, 148, 164, 168, 183, 186, 189) of the second virtual enclosure (130).

16. The non-transitory machine-readable storage medium (420) as claimed in claim 14, wherein the non-transitory machine-readable storage medium (420) includes further instructions that, when executed by at least one processor (410), cause the at least one processor (410) to generate a virtual dashboard for a tenant, upon creating one of the first and second virtual enclosures (120, 130), wherein the virtual dashboard displays alerts and notifications in relation to the one of the corresponding first and second virtual enclosures (120, 130).

17. The non-transitory machine-readable storage medium (420) as claimed in claim 14, wherein the non-transitory machine-readable storage medium (420) includes further instructions that, when executed by at least one processor (410), cause the at least one processor (410) to operate one or more resources physically distinct from the resources of the first and second virtual enclosures (120, 130), in a low power mode.

18. The non-transitory machine-readable storage medium (420) as claimed in claim 14, wherein the non-transitory machine-readable storage medium (420) includes further instructions that, when executed by at least one processor (410), cause the at least one processor (410) to reallocate one or more resources of the first virtual enclosure (120) to the second virtual enclosure (130) based on utilization of the plurality of resources of the first and second virtual enclosures (120, 130).

19. The non-transitory machine-readable storage medium (420) as claimed in claim 15, wherein the one or more polices are defined based on one or more workloads to be deployed on one of the first and second virtual enclosures (120, 130).

20. The non-transitory machine-readable storage medium (420) as claimed in claim 14, wherein the non-transitory machine-readable storage medium (420) is housed within the multi-tenant server enclosure (100).
